(19) United States
(12) Patent Application Publication
(10) Pub. No.: US 2025/0296020 A1
(43) Pub. Date: Sep. 25, 2025

(54) MODULAR FILTER SYSTEM

(71) Applicant: Piush Soni, Leicester (GB)

(72) Inventor: Piush Soni, Leicester (GB)

(21) Appl. No.: 18/765,386

(22) Filed: Jul. 8, 2024

Related U.S. Application Data
(60) Provisional application No. 63/568,462, filed on Mar. 22, 2024.

(51) Int. Cl. B01D 35/30; B01D 24/00; B01D 24/10; B01D 24/40; B01D 29/11; B01D 29/54; B01D 29/90; B01D 46/00; B01D 46/24; B01D 46/30; B01D 46/60

(52) U.S. Cl. CPC B01D 35/303; B01D 24/001; B01D 24/004; B01D 24/10; B01D 24/40; B01D 29/111; B01D 29/112; B01D 29/54; B01D 29/90; B01D 46/0013; B01D 46/0041; B01D 46/2411; B01D 46/30; B01D 46/60; B01D 2267/40; B01D 2267/60

(57) ABSTRACT

A filter system includes a first filter module having first filter module output ports near an outer perimeter of the first filter module and a first filter module center port on near a midpoint of the first filter module, a second filter module having second filter module outer ports near an outer perimeter of the second filter module and a second filter module center port near a midpoint of the second filter module, and a diverter between the first filter module and the second filter module. The diverter has an input port proximate to a midpoint of a top of the diverter and diverter exit ports proximate to an outer perimeter of a bottom of the diverter.

### CROSS-REFERENCE TO RELATED APPLICATION

This patent application claims priority to U.S. provisional patent application 63/568,462 filed on Mar. 22, 2024 which are incorporated by reference herein.

### BACKGROUND OF THE INVENTION

### Field of the Invention

The application relates to filtration devices and more particularly to filtration systems for fluids and gas.

### Background

Filtration systems for fluids (the term “fluids” includes liquids, such as, for example, water, as well as gases which may also require filtration) often fail prematurely unless they are “purpose” built. For example, a water filter system may have a generic design to handle ranges of sediment, contaminants, and microbiological threats. However, if the amount of sediment that is present exceeds the expected range, the filter system may lose its filtration ability while most the system still has available filtration capacity. This can be avoided by custom designing a water filter system based on a particular water profile such that no one element fails until the entire system is nearing its filtering capacity.

Custom designing a filter system, such as, for example, a water filter system, may result in higher costs. Thus, a need exists for a modular filtration system that handle a variety of filtration needs.

### BRIEF SUMMARY OF THE INVENTION

In one general aspect, a filter system includes a first filter module, the first filter module having one or more first filter module output ports on a top and bottom near an outer perimeter of the first filter module and a first filter module center port on a top and bottom near a midpoint of the first filter module, a second filter module having one or more second filter module outer ports on a top and bottom near an outer perimeter of the second filter module and a second filter module center port on a top and bottom near a midpoint of the second filter module, and a first diverter between the first filter module and the second filter module, the first diverter having an input port proximate to a midpoint of a top of the first diverter and one or more diverter exit ports proximate to an outer perimeter of a bottom of the first diverter, wherein the first diverter channels a gas or liquid fluid flow from the first filter center port to the second filter module outer ports.

Embodiments may include one or more of the following features. For example, the first filter module includes a first filter canister and the second filter module includes a second filter canister. The center port of the first filter module center port may be proximate to a central axis of the first filter cannister and the center port of the second filter module is proximate to a central axis of the second filter canister. In this embodiment, the output ports of the first filter module are proximate to an outer perimeter or circumference of the first filter canister and the outer ports of the second filter module are proximate to an outer circumference or perimeter of the second filter canister.

Filter modules, filter canisters and diverters may be described herein as having the shape of circular “pucks” with top and bottom circular disks attached by a perimeter or circumference wall. However, the modules, canisters and diverters may have other shapes such as, for example, a cuboid, cylinder, cone, torus, sphere, prism, etc.

The first filter canister may be a first vessel that contains a first filter media and having a first circular top, a first circular bottom and a ring-shaped first perimeter wall attached between the first circular top and the first circular bottom and the second filter canister may be a second vessel that contains a second filter media and having a second circular top, a second circular bottom and a ring-shaped second perimeter wall attached between the second circular top and the second circular bottom. The first filter canister outer ports may be in the first circular top and the first circular bottom, and the second filter canister outer ports may be in the second circular top and second circular bottom. The first canister center ports may be in the first circular top and first circular bottom and the second canister center ports may be in the second circular top and the second circular bottom.

The first filter canister be composed of a two or more first filter canisters in a stacked configuration thereby increasing fluid flow throughput and increases total loading capacity of the filter. As used herein, throughput means a volumetric flow rate or a volume passing through a filter in a time period. The second filter canister may be two or more second filter canisters in a stacked configuration thereby increasing its fluid flow. Essentially, these filter cannisters in a “parallel” configuration thereby increasing fluid flow rate. The parallel configuration is achieved by fluidly linking outer ports and center ports.

A third filter canister having one or more third canister outer ports proximate to an outer circumference (or perimeter) of a top and bottom and a center port in its top and bottom proximate to axis of the third filter canister may be linked to the second cannister by a second diverter. The second diverter blocks the outer ports of the bottom of the second cannister and the center port of the top of the third filter cannister. As such, the second diverter channels a fluid flow from the center port of the bottom of the second filter canister to the outer ports at the top of the third filter canister. This can be repeated with additional filter stages. Each diverter causes a serial flow path between the filter canisters such thereby providing additional filtration stages.

In another embodiment, each filter cannister is a sealed vessel that is divided into more than one chamber or compartment that each contains the first filter media, with each compartment fluidly connected to at least one of the filter canister output ports at its top, and each compartment fluidly connected to the center port at the bottom. The filter compartments may have a wedge shape and a circuitous flow path from one or more of the first canister outer ports to the first canister inner port or exit port. Each compartment may contain various types of filter particles or granules including active carbon and ion exchange media.

In another embodiment, filter media may be a series of more than one concentric ring filters with a flow path from the filter canister outer ports to the filter cannister center port.

Each diverter may be a sealed housing or vessel with a top portion and a bottom portion attached by a perimeter wall. The center port may be positioned in the top portion and the outer ports bottom portion proximate to an outer circumference or perimeter of the diverter. For example, the outer ports in the bottom portion may include at least three exit ports. Thus, a diverter above a filter cannister may cause fluid flow into outer ports of the filter cannister and a diverter below the filter cannister may cause fluid flow into the center port of the filter cannister.

In another general aspect, a filter system includes a first filter module having one or more input port and one or more output port, a second filter module having one or more input port and one or more output port, and a first diverter between the first filter module and the second filter module, the first diverter having at least one first diverter input port proximate to a midpoint of the first diverter and one or more first diverter output port proximate to an outer perimeter of the first diverter. The first diverter channels a fluid flow from the one or more first filter module output port to the one or more second filter module input port.

In another general aspect, a method of producing a modular filter system, includes defining a fluid input profile, setting a fluid output goal, determining each type of filter stage based on the fluid input profile and the fluid output goal, and optimizing each filter stage to meet the fluid output goal. The fluid may be a liquid, such as water, or gas.

Embodiments may include one or more of the above or following features. For example, defining the fluid input profile may include performing a fluid profile analysis or selecting a fluid profile from a data source.

Setting a fluid output goal may include setting a contaminant thresholds for

particulates, chemicals, heavy metals, and biological hazards. If the contaminant threshold is not met, the method may include adding a series-connected filter component to the filter stage.

Setting a fluid output goal may include setting a fluid throughput goal. When mentioned herein, fluid throughput does not just describe the quantity of fluid but also the contaminant loading capacity, lifespan and pressure reduction across the filter. If the fluid throughput goal is not met, the method may include adding a parallel-connected filter component to the filter stage. Setting a fluid output goal may include setting a filter maintenance schedule.

The method may include establishing a first particulate filter stage, a second chlorine filter stage and a third microbiological filter state based on the fluid input profile and fluid output goal. Optimizing each filter stage comprises optimizing the first particulate filter stage by adding a particulate filter component in parallel to increase throughput or adding the particulate filter component in series/sequentially to reduce particulate output.

Adding the additional particulate filter component in parallel may include stacking the additional filter component above an initial particulate filter component to increase throughput. Adding the additional particulate filter component in series/sequentially may include stacking a diverter plate between the additional filter component and the initial particulate filter component to reduce particulate output. Stacking additional components applies to any filter type/stage for chemical, microbiological or other filter types.

In another general aspect, a method of producing a modular filter system, includes identifying at least a first and second contaminant from a fluid input profile, selecting a first and second filter stage to reduce the first and second contaminant, wherein the first and second filter stage each include a stack of one or more first and second filter components, establishing a fluid output goal based on at least a minimum flow rate and a first and second contaminant threshold, optimizing the first filter stage by adding a first filter component to the stack of one or more first filter components in a series connected fluid path or a parallel connected fluid path until the first contaminant threshold and minimum flow rate are achieved, and optimizing the second filter stage by adding a second filter component to the stack of one or more second filter components in a series connected fluid path or a parallel connected fluid path until the second contaminant threshold and minimum flow rate are achieved.

The method may include one or more of the above or following features. For example, adding the first filter component may include connecting the added first filter component directly to the stack of one or more first filter components to increase a flow rate or connecting a diverter plate between the added first filter component and the stack of one or more first filter components to reduce the first contaminant threshold. Connecting the diverter plate may include redirecting a fluid flow between one or more fluid output of the added first filter component to one or more fluid input of the stack of one or more first filter components.

Adding the second filter component may include connecting the added second filter component directly to a stack of one or more second filter components to increase a flow rate of the second filter stage or connecting a diverter plate between the added second filter component and a stack of one or more second filter components to reduce the first contaminant threshold of the first filter stage. Connecting the diverter plate may redirect one or more fluid input to the stack of one or more modular second filter components or one or more fluid output from the added second filter component to one or more fluid input to the stack of one or more second filter components.

The method may further include adding the first filter component may include stacking a diverter in a series connected fluid path or a parallel connected fluid path until the first contaminant threshold and minimum flow rate are achieved and optimizing the second filter stage by adding a second filter component in a series connected fluid path or a parallel connected fluid path until the second contaminant threshold and minimum flow rate are achieved.

In still another general aspect, a method of designing a modular filter system includes setting a fluid output goal, optimizing a filter model to meet the fluid output goal, implementing the optimized filter model in a filter project, storing filter project data, comparing the optimized filter model to the stored filter project data, and updating the optimized filter model when the when the stored filter project data doesn't meet the fluid output goal.

Embodiments may include any of the above or following features. For example, the method may include defining a fluid input profile and optimizing the filter model based on the fluid input profile and the fluid output goal. Defining the fluid input profile may include performing a fluid analysis or recalling a fluid profile from a database. The method may also include utilizing stored filter project data to update the optimized filter model for the unique fluid input profile.

### BRIEF DESCRIPTION OF THE SEVERAL VIEWS OF THE DRAWINGS

FIGS. 1-3 illustrate modular filter systems;

FIG. 4 shows a fluid path through a modular filter system;

FIGS. 5A and 5B illustrate fluid paths for a filter canister and a diverter of a modular filter system;

FIGS. 6A and 6B illustrate fluid paths for a stack of filter canisters with and without diverters;

FIGS. 7A, 7B, 7C and 7D are various views of the diverter;

FIG. 8 is another view of the diverter;

FIG. 9 shows a contaminant filter module;

FIGS. 10A and 10B are additional views of a contaminant filter module.

FIGS. 11A and 11B, show adsorption particles used in a contaminant filter module;

FIGS. 12A, 12B and 12C, show a graphic user interface to custom design a modular filter system; and

FIGS. 13A, 13B, 13C, 13D, 13E and 13F, are flowcharts that illustrate a method of designing and optimizing a modular filter system.

### DETAILED DESCRIPTION OF THE PREFERRED EMBODIMENTS

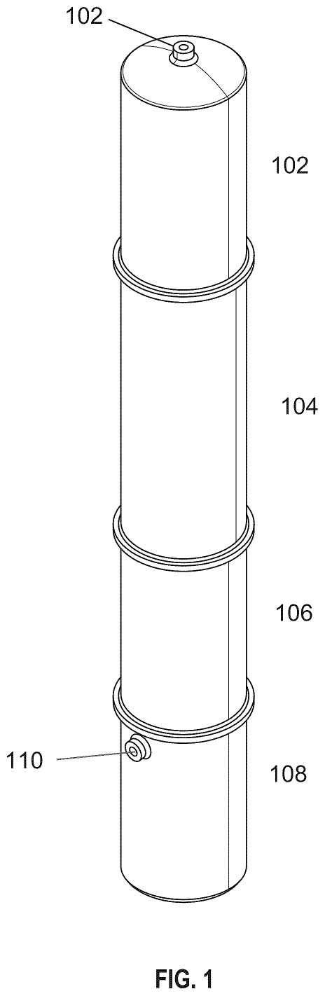

Referring to FIG. 1, a modular filter system 100 includes a series of filters (not shown) that are positioned in a vertical column and covered with stacking shrouds or covers 102, 104, 106, 108. Gas or fluid (sometimes both referred to hereafter as fluid), such as, for example, water or air, enters through an entry port 110 in the top shroud 102 and the filtered gas or fluid leaves the modular filter system 100 through an exit port 112 in the bottom shroud.

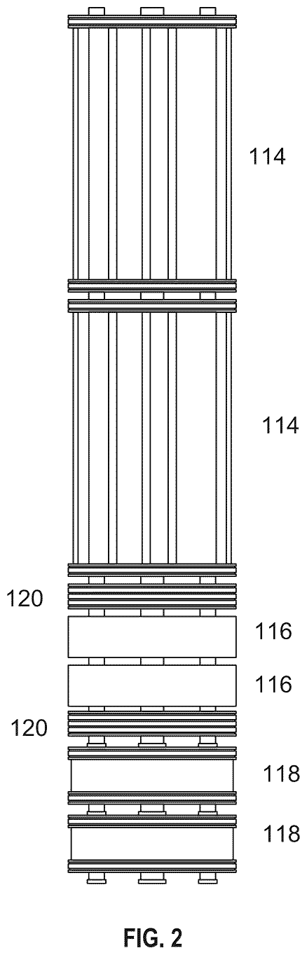

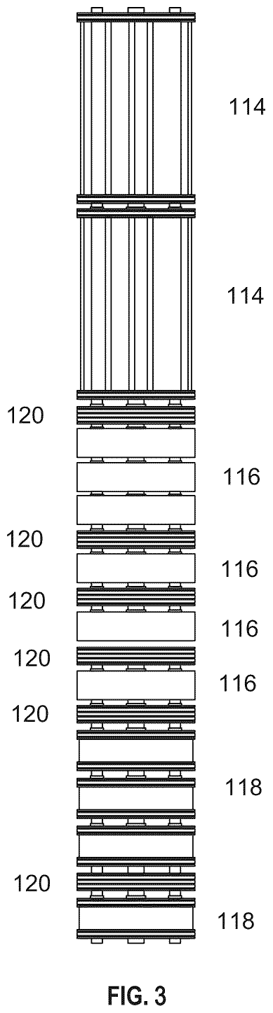

Referring to FIGS. 2-3, the modular filter system can use filter cannisters in a variety of configurations depending on the type of contaminants in the fluid and the desired filtration levels. Referring to FIG. 2, three filter types 114, 116, 118 are double stacked on top of each other and the filter stages (first, second and third filter types) are separated by diverters or diverter plates 120.

Each of the filter cannisters 114, 116, 118 have open ports around the outer perimeter and a center or inner port at the top and bottom. The filter cannisters may be sediment filters 114, contaminant filters 116 and microbiological filters 118. The sediment filters 114 remove mostly sediment particles that are suspended in the fluid. The filters can be used in single, double, triple or other stacked configuration based on the necessary throughput. Generally, the sediment filters 114 are positioned at the top or first position of the stack since they handle more of the bulk sediment particles that could foul or plug other types of filters. The sediment filters 114 may be composed of various layers of fibrous materials.

The contaminant filters 116 remove volatile organic compounds, heavy metals, chloramines, synthetic chemicals such as perfluoroalkyl and polyfluoroalkyl substances (PFAS) and other contaminants from drinking water.

The contaminant filters 116 may be, for example, carbon, activated carbon solids or granules, ion exchange media kinetic degradation fluxion (KDF) or any other suitable filter such as those utilizing “redox” (oxidation/reduction) processes. In some contexts, “contaminant filter” may refer more generally to describe various types of filter types.

Microbiological filters 118 may be used in the third stage. This may include ultraviolet light, permeable membrane filters, electropositive pleated filters, microporous filters, microglass filaments positively charged membrane filters and other media. A solar charging system may be used to power the ultraviolet light in remote locations.

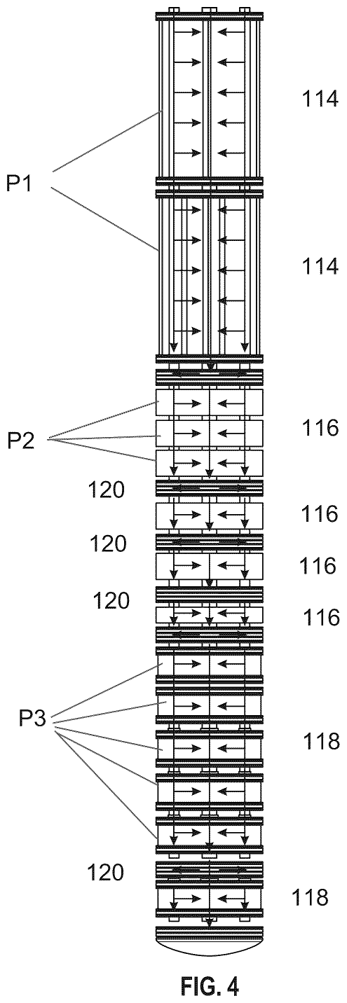

Referring to FIG. 4, fluid or gas flows sequentially in multiple stages (different filter types) through filter cannisters 114, 116, 118. A pair of sediment filters 114 are present in the filter stack that operate in parallel, represented by P1, for increased throughput. A diverter 120 is positioned between the sediment filters 114 and the next stage or filter type 116.

The contaminant filters 116 and microbiological filters 118 are configured in a more complex configuration. Three contaminant filters 116 are operated in parallel P2, then three (3) contaminant filters 116 are operated in series (sequentially) by positioning a diverter 120 between each filter. Next, five (5) microbiological filters 118 are operated in parallel P3, and then a microbiological filter 118 separated by a diverter 120 is operated as the last stage.

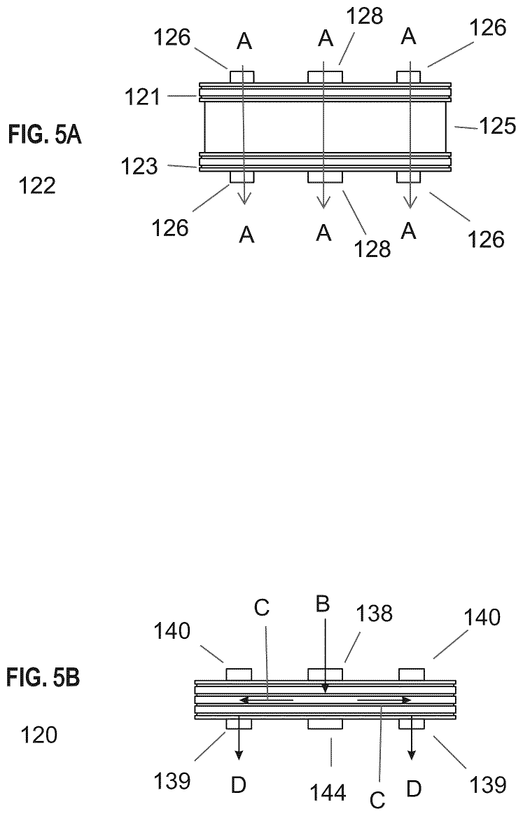

Referring to FIG. 5A, fluid flow is shown through a filter canister 122. The filter canister has a top 121 and bottom 123 connected by a perimeter wall 125. Outer ports 126 and inner ports 128 are on the top 121 and bottom 123. The filter canister may be a vessel or housing with a filter media with the fluid flow through outer and inner ports 126, 128. Fluid flow through the canister 122 is shown by arrow A which may be directly through the canister 122. Fluid may also flow or migrate laterally depending on the filter type and condition.

Referring to FIG. 5B, the diverter 120 has a central or top port 138 and outer perimeter ports 139 at the bottom. The fluid enters the center or inner port 138 at the top of the diverter 120 and exits the through the outer ports 139 at the bottom of the diverter 120. Fluid flows in the diverter 120 are shown by arrows B, C and D. The fluid flows vertically into the center port 138 as shown by arrow B. Then, fluid flows outward toward the perimeter as shown by arrow C. The fluid exits the diverter 120 from the outer ports 139 as shown by arrow D.

Another way of describing the fluid flow is that the filters 122 operate in parallel when no diverter is positioned between the filter and in series (sequentially) when a diverter 120 is connected between adjacent filters. Parallel flow increases throughput (volumetric flow rate) while serial flow reduces contaminant levels.

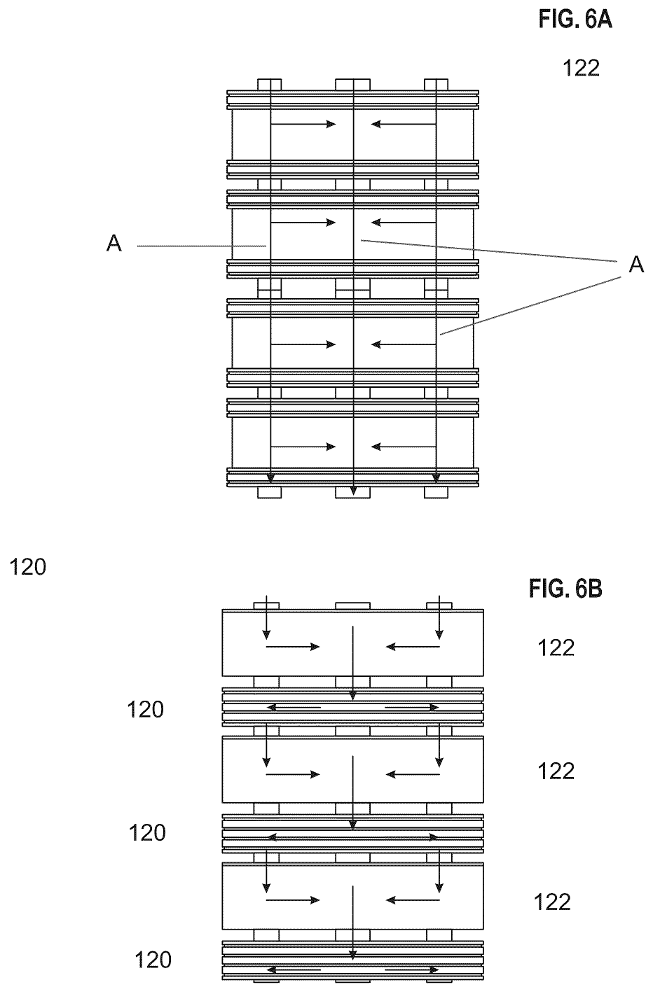

FIG. 6A illustrates fluid flow in a stack of filter canisters 122 that are directly connected and FIG. 6B shows fluid flow through the canisters 122 with diverters 120 between each canister 122. In FIG. 6A, no diverters are used in a stack of four connected filter cannisters 122 which may be any type of filter purpose or media. The filter cannisters have open outer ports 126 around the perimeter and a center or inner port 128 in the center at the top and bottom. Fluid enters through the ports 126, 128 in the top filter cannister and then it is free to flow down into adjacent filters through the outer ports 126 or the center (inner) port 128, with the fluid flow being shown by arrows. This includes vertical flow directly between each cannister 122 along with some horizontal flow within the cannister 122.

Referring to FIG. 6B, a diverter 120 is positioned between adjacent filter cannisters 122. Fluid enters the filter cannisters 122 through the outer ports 126 at the top. However, the diverter blocks the fluid flow from the bottom of each cannister through the outer ports 126. Thus, the fluid must migrate from the outer ports 126 through filter media to the center of the cannister 122 to exit the cannister from its center or inner port 128.

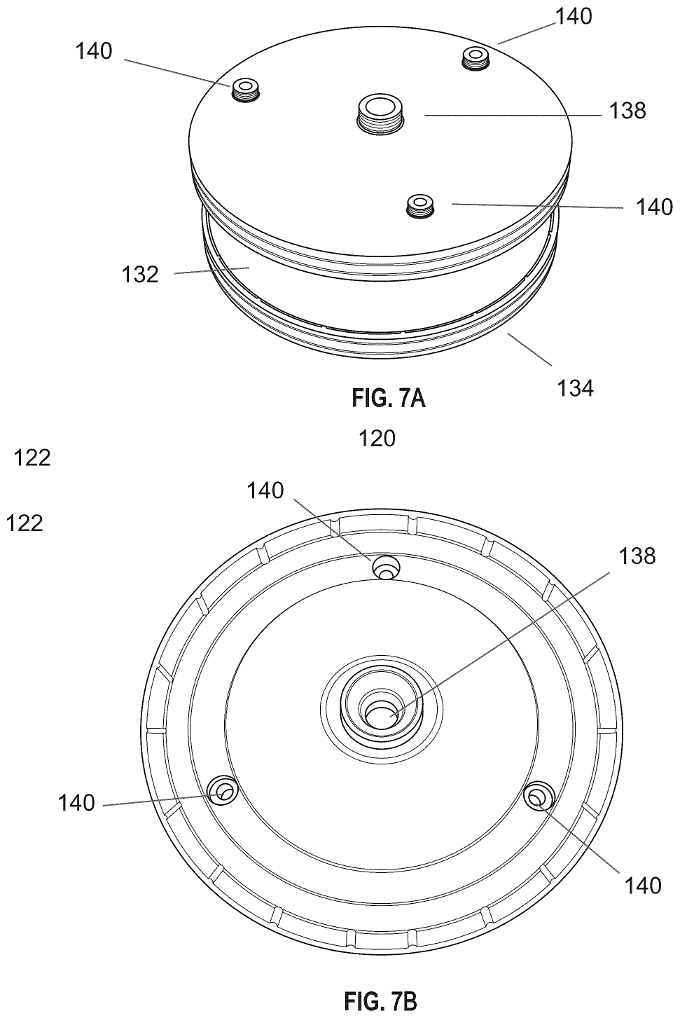

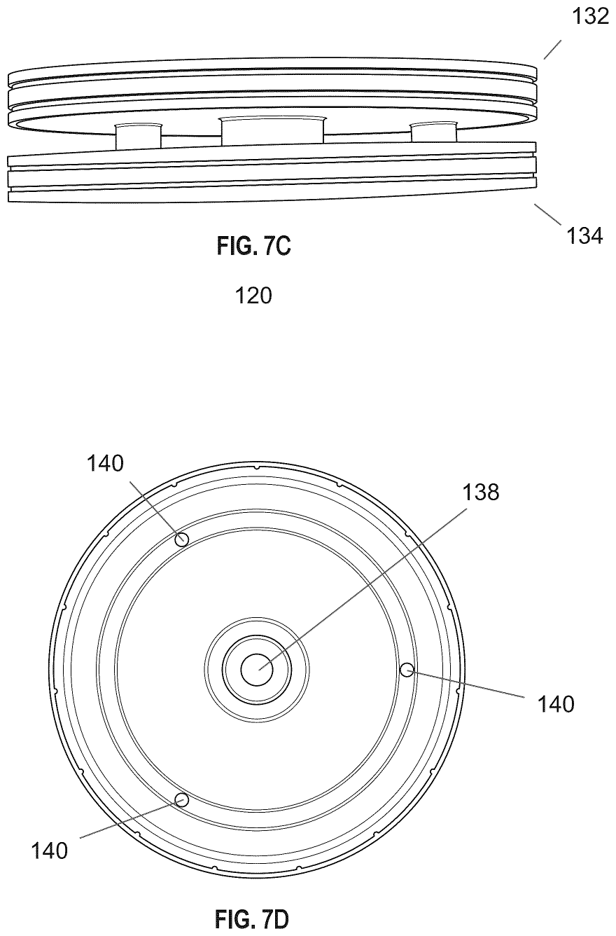

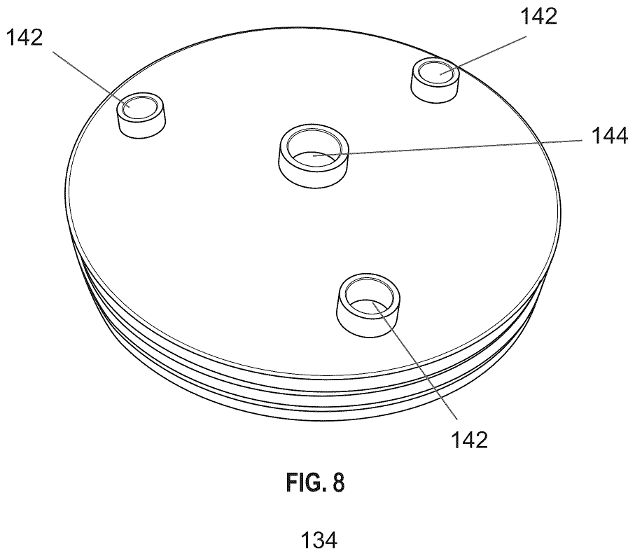

A perspective view of a diverter 120 is shown in FIG. 7A. The diverter has a top plate 130, a side wall 132 and a bottom plate 134. The top plate has an open center inner port 138 and mounting posts 140. The term “open” refers to allowing fluid flow and “closed” refers to blocking fluid flow. In the embodiment shown, there are three outer mounting posts 140 around a circular disk-shaped top plate 130. Generally, the posts connect adjacent filters but also block fluid flow from filter ports.

In the embodiment shown, the diverter 120 has three mounting posts 140 that match the ports of the filter cannister (not shown). However, more or fewer posts may be available and the diverter 120 and its associated plates 130, 132, 134 may have other shapes such as, for example, rectangular, oval, triangular or octagonally shaped perimeters.

FIGS. 7B, 7C and 7D show an inverted view of the top plate of a diverter 120, partially expanded view of the diverter and a top view of the top plate 130 of the diverter 120, respectively. In this embodiment, the diverter 120 has a “clam shell” design wherein the side walls are partially built into the top plate 132 and the bottom plate 134 that are attached to each other to close the “shell.”

FIG. 8 is an inverted view of the bottom plate 134 of the diverter 120. The bottom plate 134 of the diverter has open outer ports 142 and a center mounting post 144 that blocks or is closed to fluid flow.

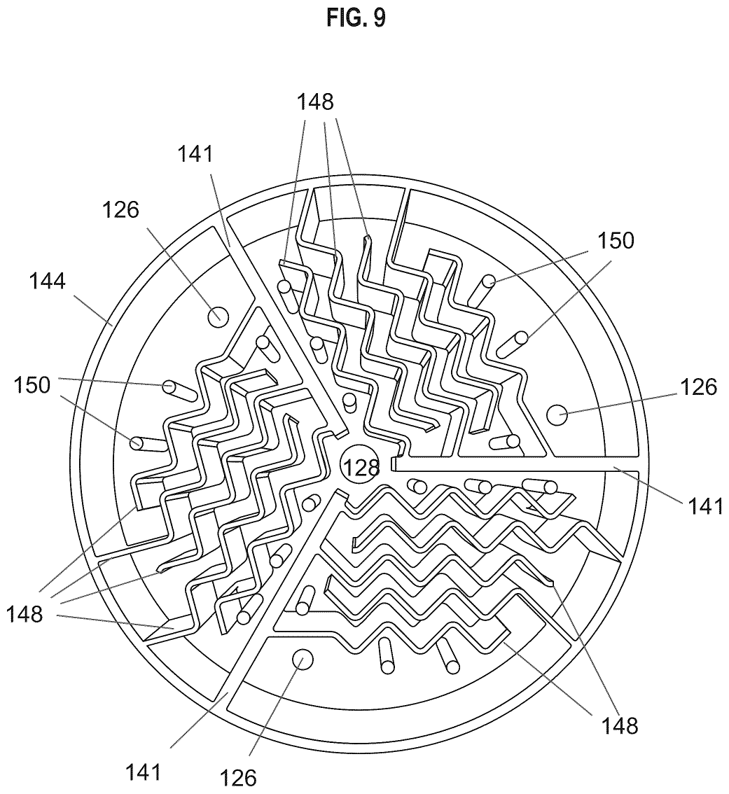

FIG. 9 illustrates an embodiment of a contaminant filter 116 with the top removed. Three dividing walls 141 divide the internal volume into chambers that provide redundancy with separate fluid paths. The contaminant filter 116 has outer ports 126 and a center or inner port 128 that are open to fluid flow at the top and bottom. In the embodiment shown, the sediment filter has a top and bottom outer port 126 in each chamber. A diverter (not shown) can be used above the contaminant filter 116 to block the top center port. A diverter (not shown) can be used below the sediment filter 114 blocks the bottom outer ports 126.

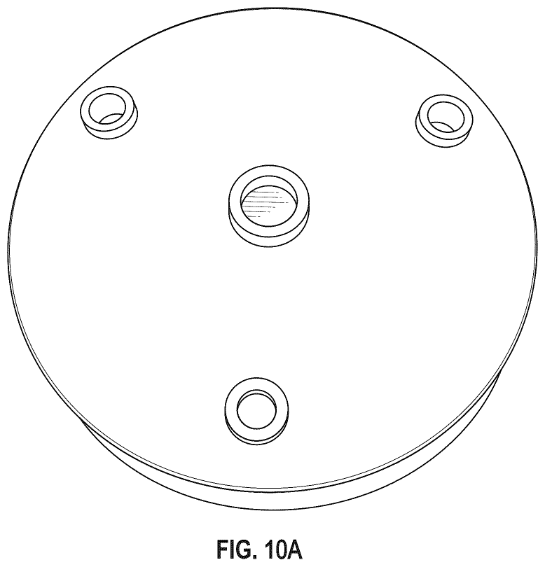

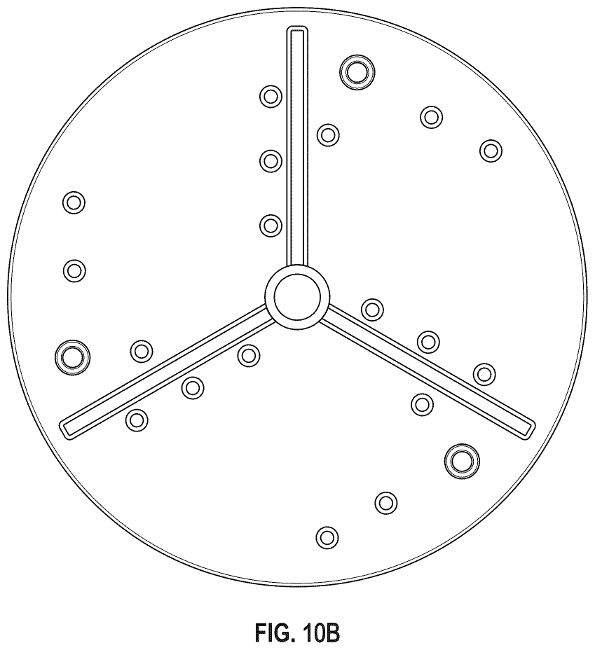

FIGS. 10A and 10B show the top and bottom of the contaminant filter 116. The base portion 140 of the contaminant filter 116 is shown in FIG. 10A and the top cover 142 is shown in FIG. 10B. The top cover 142 is essentially a dome that is fixed to the base portion 140, the top cover 142 having open outer ports 126 and an open center port 128.

The base portion 140 is shaped as a disc with a circular side wall 144. The base portion 140 is divided into three chambers or compartments by three chamber walls 146 that run from the side wall 144 to near the center port 128. Referring again to FIG. 9, a series of wave shaped channel walls 148 create a series of circuitous or maze-like channels from the outer ports 126 to the center port 128.

Mounting posts 150 may be positioned on the disc to mount the base portion 140 to the top cover 142 along with mounting recesses 152 that receives the posts 150 on the under side of the top cover 142.

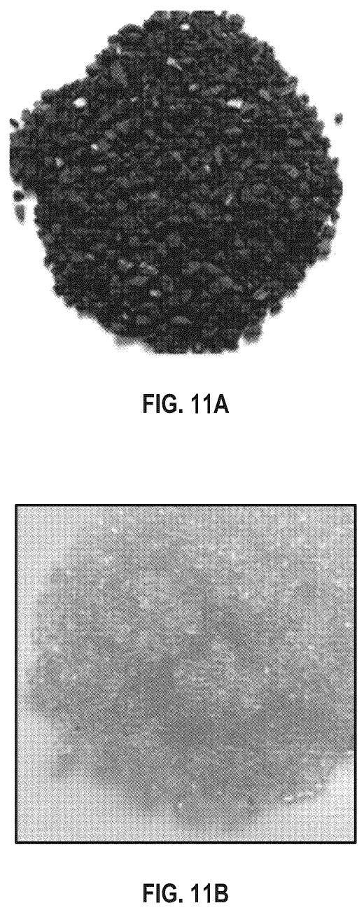

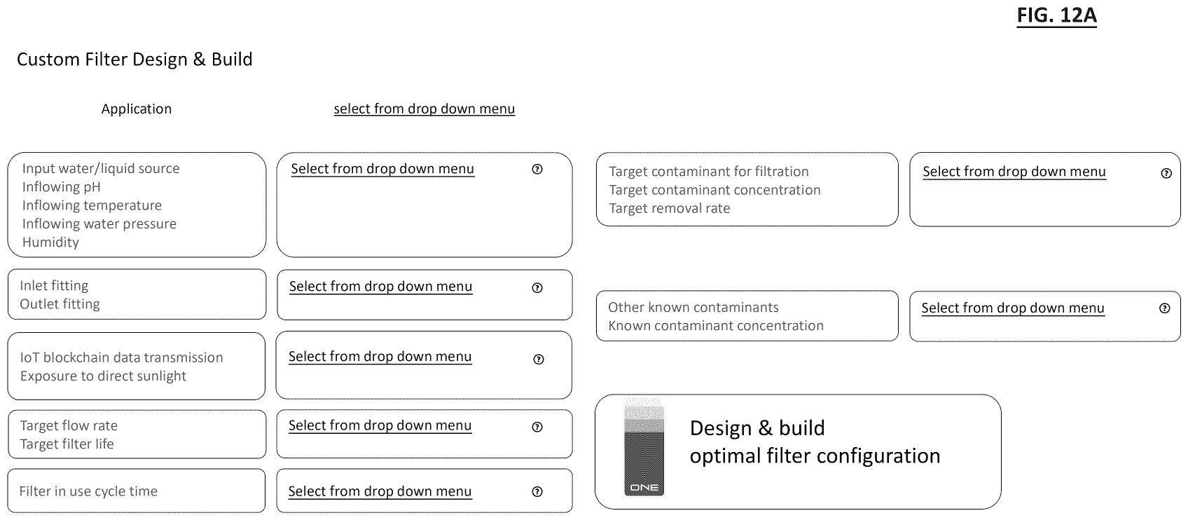

Referring to FIGS. 11A and 11B, adsorption particles, such as, activated carbon granules, ion exchange resin or other filter media, may be deposited in the series of channels in the base portion 140. The outer ports 126 and 128 may be covered with mesh to be permeable to water but retain the carbon granules or other filter media.

As mentioned above, a modular filter system utilized modular components to produce a desired fluid based on the initial fluid profile and the desired output quality. For example, water filtration may require at least three types of filter components for sediment particles, contaminants and microbiological organisms.

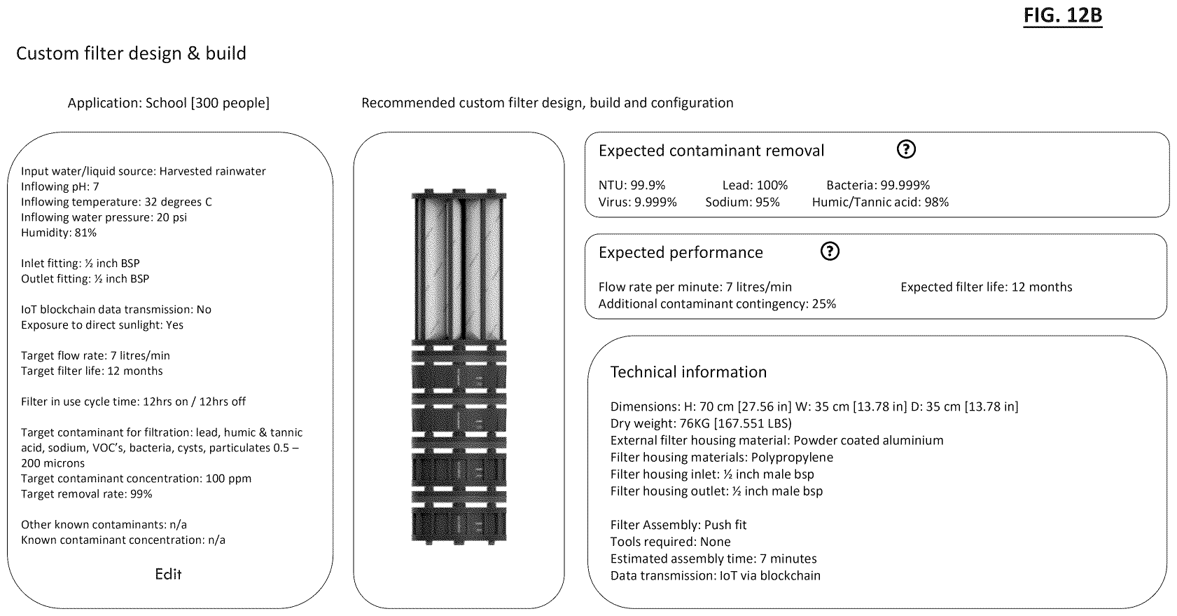

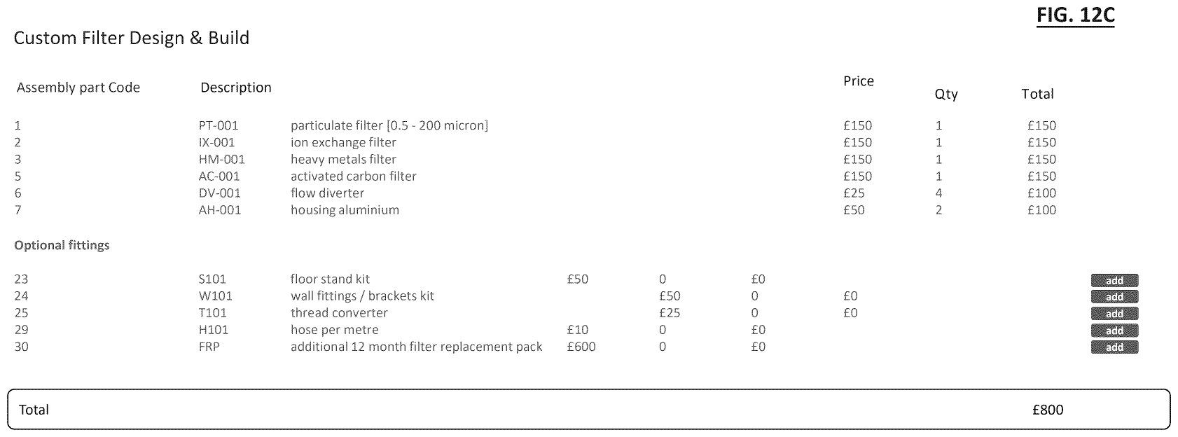

Referring to FIGS. 12A, 12B and 12C, a filter designer can utilize a software application to customize the filter design. The design provides a water profile with several input and output parameters. This may include information to identify the input water/liquid source to identify a preexisting water analysis report. The information input may include contamination levels and contamination output targets along with water pH, temperature and pressure. Other information may be collected such as ambient humidity and sunlight access along with inlet and outlet fitting sizes, and targets for filter life and flow rates. Referring to FIG. 12C, the designer can be provided with an itemized custom filter system cost for the filter that is built based on the input features and desired output quality.

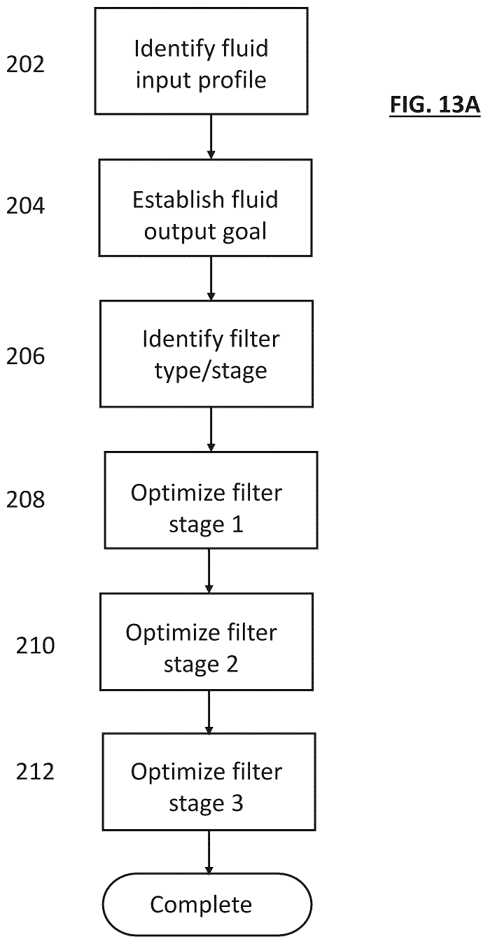

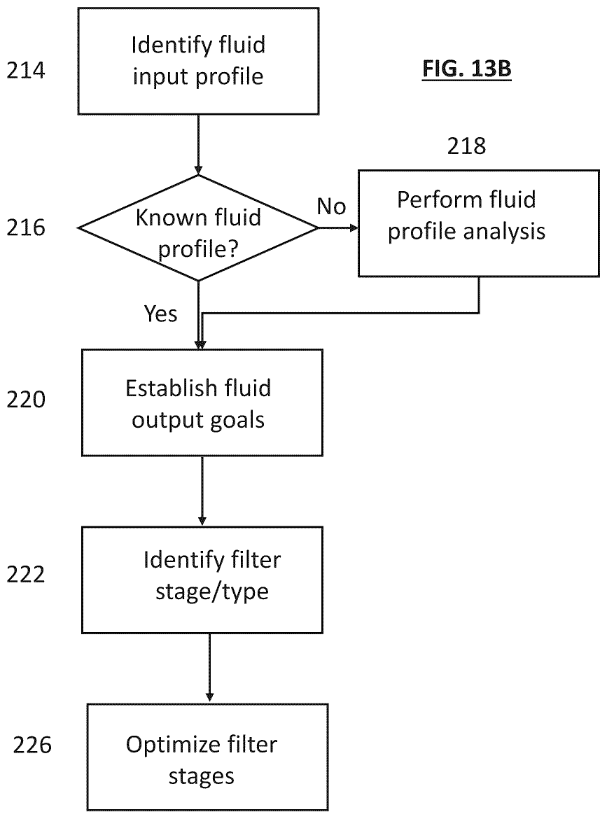

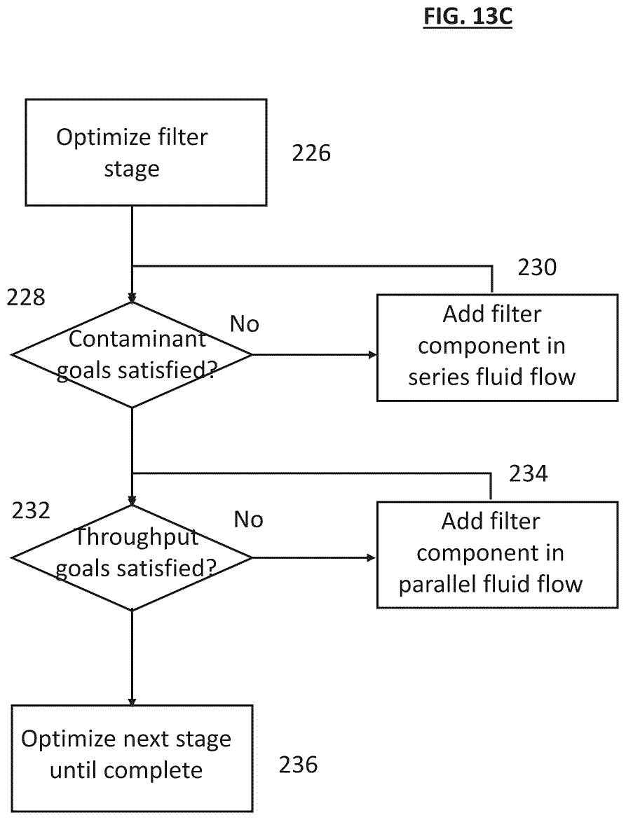

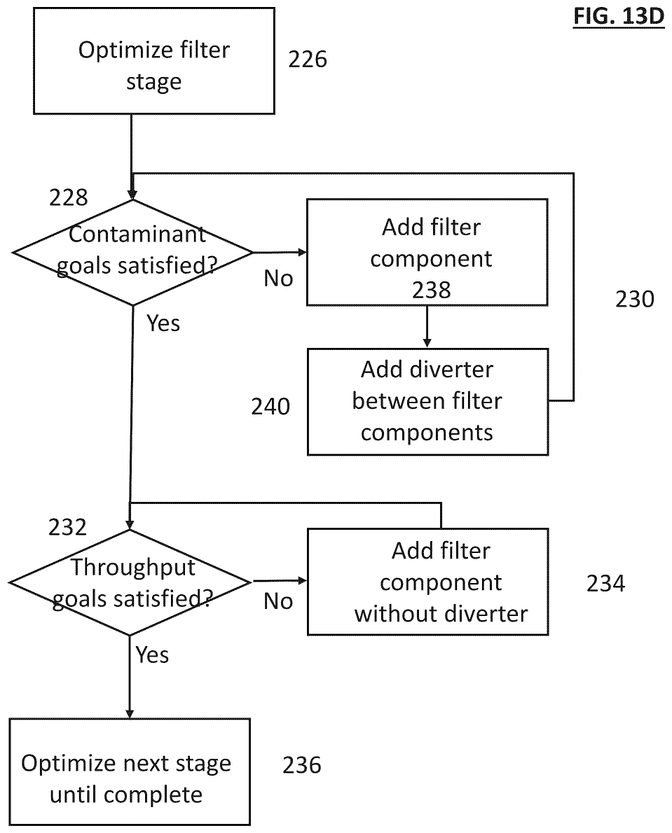

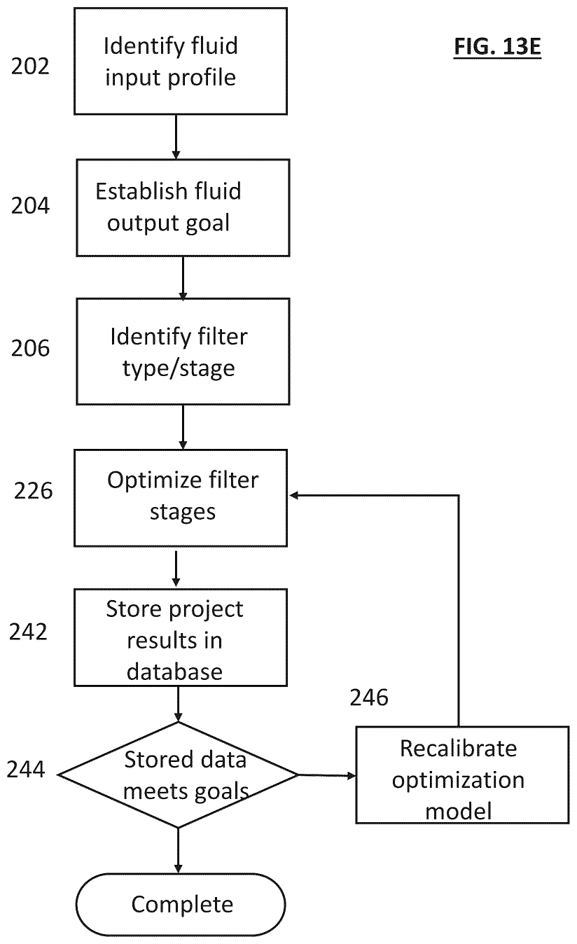

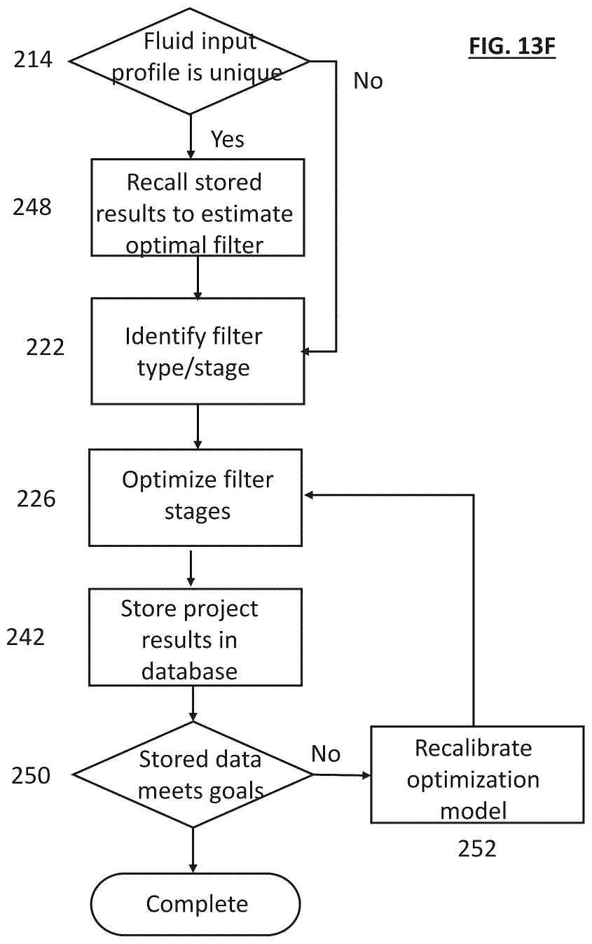

Referring to FIGS. 13A, 13B, 13C, 13D, 13E and 13F, flowcharts illustrate a method building a modular filter system with the software application and aided by artificial intelligence to optimize the filter system.

Referring to FIG. 13A, the fluid input profile is identified in step 202. This may include reference to a known water profile or a water profile analysis. Fluid output goals are specified in step 204.

The filter type/stage is identified in step 206. This may be sediment, contaminant or microbiological filtration.

In step 208, the method optimizes the first stage of the filter. The method adds more filter components in parallel as more throughput is needed and more filter components in series as more stringent filtration quality is needed.

As an example, in a high sediment environment the first stage may be sediment filters that are placed in parallel until an adequate throughput is achieved. Then a another set of sediment filters may be added to improve filtration quality. Computer aided optimization/artificial intelligence may assist by accessing previously designed and tested filtration systems and access to follow-up test results.

The system may design around, for example, seven (7) modular sediment filter components but then optimize as 3-2-1 (three in parallel, then two in parallel and then one filter) or a 4-3 (four in parallel, then three in parallel) by analyzing filter life and throughput goals.

After first stage filters are optimized in step 208, the second stage filters are optimized in step 210 by adding filter components until throughput and quality thresholds are achieved.

Next, third stage filtration optimization is achieved in step 212 by adding filter components to satisfy throughput and fluid quality output goals.

Generally, optimization of each filter stage 208, 210 and 212 occurs in sequential order with the lower number stages being handled first. This may be due to the comparative cost of the filter media or the level of the contaminant burden on the type of filter. While the method of described in FIG. 13A outlines three stages, additional or fewer stages can be used depending on the fluid profile and output goals.

Referring to FIG. 13B, during the optimization of each stage 208, 210 and 212, a fluid profile requested in step 214. In step 216, a resource, such as, for example, a database, is consulted for an existing fluid profile. If the fluid profile is unknown or cannot be determined the fluid profile is analyzed in step 218. Fluid output goals are established in step 220. This process is repeated for each filtration stage in step 222 and 224.

Referring to FIG. 13C, the filter stage optimization process 226 is set forth in more detail. The filter configuration is tested to satisfy contaminant reduction thresholds in step 228. If contaminant goals are not satisfied additional filter elements are added in step 230.

Once contaminant goals are achieved the throughput goals are measured in step 232. If the throughput goals are not achieved, modular filter elements are added in parallel in step 234. The process is repeated until the target contaminant and throughput levels are achieved in step 236.

FIG. 13D outlines provides more detail on the filter stage optimization process. When the contaminant threshold is not met an additional filter component and diverter are added in steps 238, 240. Filter components are added without a diverter to increase throughput.

Referring to FIGS. 13E and 13F, the filtering optimization can be improved by examination of field results from previous constructed water filtration projects. Water project test results are stored in a database in step 242. The stored results are tested against design expectations in step 244. In the event that the actual results don't meet expectations the optimization modeling is recalibrated in step 246.

The description above has been described with reference to particular embodiments, however, various changes may be made and equivalents may be substituted without departing from the spirit and scope of the invention. In addition, many modifications may be made to adapt to a particular situation, material, composition of matter, process, process step or steps, to the scope of the present disclosure. For example, the filter media may be other types of materials or may be in other configurations. The filter system may be used for other any type of fluid which could be gas or liquids. As another example, sediment filters may have other shape or design, such as, a rectangle, globe or bag. All such modifications are intended to be within the scope of the claims provided below.

1. A filter system, comprising:
a first filter module, wherein the first filter module comprises one or more first filter module outer ports proximate to an outer perimeter of the first filter module and one or more first filter module inner port proximate to a midpoint or central position of the first filter module;
a second filter module, wherein the second filter module comprises one or more second filter module outer ports proximate to an outer perimeter of the second filter module and one or more second filter module inner port proximate to a midpoint or central position of the second filter module; and
a first diverter between the first filter module and the second filter module, the first diverter having a first diverter inner port proximate to a midpoint of the first diverter and one or more diverter outer ports proximate to an outer perimeter of the first diverter;
wherein the first diverter channels a gas or liquid fluid flow from the first filter module inner port to the second filter module output ports.

2. The filter system of claim 1, wherein
the first filter module comprises a first filter canister and the second filter module comprises a second filter canister;
the first filter module outer ports comprise one or more first filter canister outer ports proximate to an outer perimeter of the first filter canister and the second filter module outer ports comprise one or more second filter canister outer ports proximate to an outer perimeter of the second filter canister; and
the first filter module inner port comprises a first filter canister inner port proximate to a central axis of the first filter cannister and the second filter module inner port comprises a second filter canister inner port proximate to a central axis of the second filter canister.

3. The filter system of claim 2, wherein the first filter canister comprises a first vessel that contains a first filter media and having a first top, a first bottom and a first perimeter wall attached between the first top and the first bottom and the second filter canister comprises a second vessel that contains a second filter media and having a second top, a second bottom and a second perimeter wall attached between the second top and the second bottom;
the first filter canister outer ports comprise first filter canister outer ports in the first top and the first bottom and the second filter canister outer ports comprise second filter canister outer ports in the second top and the second bottom; and
the first canister inner port comprises the first canister inner port in the first top and the first bottom and the second canister outer port comprises the second canister outer port in the second top and second bottom.

4. The filter system of claim 3, wherein
the first filter canister comprises a pair of the first filter canisters in a stacked configuration thereby doubling a throughput or volumetric flow rate of a fluid flowing through the pair of first filter canisters; and
the second filter canister comprises a pair of second filter canisters in a stacked configuration thereby doubling a throughput of a fluid flowing through the pair of second filter canisters.

5. The filter system of claim 3, wherein
the first filter canister comprises a pair of the first filter canisters in a parallel configuration thereby increasing a flow rate of a fluid flowing through the pair of first filter canisters; and
the second filter canister comprises a pair of second filter canisters in a parallel configuration thereby increasing a flow rate of a fluid flowing through the pair of second filter canisters.

6. The filter system of claim 5, wherein the pair of first filter canisters comprise the parallel configuration by fluidly linking the first canister outer ports between the pair of first filter canisters and the second filter canister comprise the parallel configuration by fluidly linking the second canister outer ports between the pair of second filter canisters.

7. The filter system of claim 3, wherein
the first filter canister comprises three first filter canisters with the first filter outer ports of each of the three first filter canisters fluidly linked in a parallel configuration thereby increasing a flow rate of a fluid flowing through the three first filter canisters; and
the second filter canister comprises three second filter canisters with the second filter outer ports of each of the three second filter canisters fluidly linked in a parallel configuration thereby increasing a flow rate of a fluid flowing through the three second filter canisters.

8. The filter system of claim 3, wherein
the first vessel is divided into more than one first filter compartment that each contains the first filter media, each first compartment is fluidly connected to at least one of the first canister outer ports, and each first filter compartment is fluidly connected to the first canister inner port; and
the second vessel is divided into more than one second filter compartment that each contains the second filter media, each second filter compartment is fluidly connected to at least one of the second canister outer ports, and each second filter compartment is fluidly connected to the second canister inner port.

9. The filter system of claim 8, wherein the first filter media comprises first filter particles or granules contained in each first filter compartment and wherein each first filter compartment comprises a sector shape an internal flow path from one or more of the first canister outer ports to the first canister inner port.

10. The filter system of claim 3, wherein the second filter media contained in the second vessel comprises a series of more than one concentric ring filters with a flow path from the one or more second canister outer ports to the second canister inner port.

11. The filter system of claim 1, wherein the first diverter comprises a housing or vessel with a top portion and a bottom portion with the input port in the top portion proximate to a center of the first diverter and exit ports in the bottom portion proximate to an outer perimeter of the first diverter.

12. The filter system of claim 11, wherein the exit ports of the first diverter align with the outer ports of the second filter module.

13. A filter system, comprising:
one or more first filter module having a first top and a first bottom attached by a first perimeter wall, first perimeter ports proximate to the first perimeter wall in the first top and the first bottom and a first central port in the first top and the first bottom proximate to a first center or central axis of the first filter module;
one or more second filter module having a second top and a second bottom attached by a second perimeter wall, second perimeter ports proximate to the second perimeter wall in the second top and bottom and a second central port in the second top and second bottom proximate to a second center or central axis of the second filter module; and
a diverter between the first filter module and the second filter module, the diverter having a diverter top and a diverter bottom attached by a diverter perimeter wall, the diverter having at least a diverter input port in the diverter top proximate to a center or central axis of the diverter and one or more diverter output port in the diverter bottom proximate to the diverter perimeter wall;
wherein the diverter channels a fluid flow from the first central port in the first bottom to the second perimeter ports of the second top of the second filter module.

14. The filter system of claim 13, wherein the diverter blocks fluid flow from the first perimeter ports in the first bottom and blocks fluid flow into the second central port of the second top to channel the fluid flow.

15. A method of designing a modular filter system, comprising:
defining a fluid input profile;
setting a fluid output goal based on fluid quality and throughput;
identifying one or more filter stage based on the fluid input profile and the fluid output goal; and
adding a filter component to the filter stage in series to increase the fluid quality and in parallel to increase the throughput until the fluid output goal is satisfied.

16. The method of claim 15, wherein setting a fluid output goal comprises setting a contaminant threshold.

17. The method of claim 15, wherein adding the filter component in parallel comprises stacking the filter component on the filter stage to increase throughput.

18. The method of claim 15, further comprising providing a diverter having an input port and output ports; and
wherein adding the filter component to the filter stage in series includes positioning the diverter between the filter component and the filter stage to cause a serial fluid flow between the added filter component and the filter stage.

19. A method of producing a modular filter system, comprising:
identifying a contaminant from a fluid input profile;
selecting a filter stage or type to reduce the first contaminant;
establishing a fluid output goal based on at least a minimum flow rate and a contaminant threshold;
providing a diverter plate that redirects a fluid flow between adjacent filters in the filter stage;
adding a first filter component to the filter stage without a diverter plate causing a parallel connected fluid path between the added first filter component and the filter stage to increase the minimum flow rate until the fluid output goal is achieved; and
adding a first filter component to the first filter stage with the diverter plate causing a series connected fluid path between the first filter component and the filter stage to reduce the first contaminant levels until the fluid output goal is achieved.
